(19) United States
(12) Patent Application Publication
(10) Pub. No.: US 2006/0259239 A1
(43) Pub. Date: Nov. 16, 2006

(54) System and method for providing multimedia tours

(76) Inventor: Guy Nouri, Hillsdale, NY (US)

Correspondence Address: HOFFMAN WARNICK & D'ALESSANDRO, LLC, 75 STATE STREET, 14TH FLOOR, ALBANY, NY, 12207, US

(21) Appl. No.: 11/405,328

(22) Filed: Apr. 17, 2006

Related U.S. Application Data
(60) Provisional application No. 60/675,199, filed on Apr. 27, 2005.

(51) Int. Cl. G01C 21/32

(52) U.S. Cl. 701/211

(57) ABSTRACT

A system and method for generating and publishing multimedia tours. A system is provided that includes: a tour editing system for creating and editing a tour at a first client system, wherein the tour editing system includes a system for capturing images of different formats, a system for converting captured images to tour images having a common format, and a system for storing the tour in a remote database located apart from said first client system; and a tour presentation system having a tour player that can be run from a second client system, wherein the tour player includes a system for accessing the tour and any updates from the remote database, a system for playing the tour, a system for linking to content associated with tour images appearing in the tour, and a system for forwarding tours and associated dynamically updated advertisements by email.

The present invention claims priority to co-pending U.S. Provisional Patent Application Ser. No. 60/675,199, filed on Apr. 27, 2005, entitled “SEARCHWARE.”

### BACKGROUND OF THE INVENTION

1. Technical Field

The present invention relates generally to providing on-line multimedia tours, and more specifically relates to a system and method for building, publishing, searching, viewing, and forwarding tours of multimedia content that provides a dynamic, rules based advertising/transactional model.

2. Related Art

The ability to effectively present multimedia content, including Web pages, in the form of a tour has tremendous potential for enriching the content based viewing experience for online users. Tours provide a mechanism through which one user can present content in a particular fashion that has the potential of being useful for many other users. For instance, a well thought out tour of various Web pages related to a given vacation destination could be extremely useful for others planning a similar vacation.

While various approaches to providing Web-based tours currently exist, none provide a comprehensive approach that allows for building, publishing, searching, viewing and forwarding tours of multimedia content, as well as related advertising and transactions. For instance, U.S. Pat. No. 5,760,771, issued to Blonder et al., on Jun. 2, 1998, entitled, System and Method for Providing Structure Tours of Hypertext Files, which is hereby incorporated by reference, teaches a system for providing tours of hypertext files (i.e., Web pages). However, the reference does not allow for the inclusion of non-hypertext files (e.g., JPEG pictures) to be presented as part of the tour. Moreover, the reference does not provide a mechanism that allows the tour and/or related advertising and transactions to be readily published, searched and forwarded.

In addition, none of the current approaches to generating and providing tours have incorporated a realistic revenue model required to sustain use and interest in such an application. In particular, none teach a workable model for capturing advertising/transactional revenue that can be linked to each tour and forwarded as each tour is emailed. Without such a revenue model, wide scale use of such a product is unlikely.

Accordingly, a need exists for a system and method for building, publishing, searching, and viewing tours of multimedia content that includes workable revenue models.

### SUMMARY OF THE INVENTION

The present invention addresses the above-mentioned problems, as well as others, by providing a system and method for building, publishing, searching, and viewing tours of multimedia content that provides a dynamic rules based advertising/transactional model. In a first aspect, the invention provides a system for providing multimedia tours, comprising: a tour editing system for creating and editing a tour at a first client system, wherein the tour editing system includes a system for capturing images of different formats, a system for converting captured images to tour images having a common format, and a system for storing the tour in a remote database located apart from said first client system; and a tour presentation system having a tour player that can be run from a second client system, wherein the tour player includes a system for accessing the tour from the remote database, a system for playing the tour, and a system for linking to content associated with tour images appearing in the tour.

In a second aspect, the invention provides a method for playing a tour in a viewer, comprising: pointing the viewer to a tour database having a plurality of tours stored therein, wherein the tour database is remotely located from a device running the viewer; displaying a tour player in the viewer; playing the tour in the tour player; and displaying ad content in relation to the viewer with the tour player, wherein the ad content is dependent upon a set of ad rules.

In a third aspect, the invention provides a method for composing a tour that can be played in a Web browser, comprising: capturing images from Web pages being viewed on a computer system, wherein the Web pages have an HTML format; converting the captured images to a set of tour images having a non-HTML format; composing the tour from the tour images; and storing the tour in a remote database located apart from the computer system.

In a fourth aspect, the invention provides a computer program product stored in computer memory that is downloadable to a remote computer system where the computer program product can be executed in a Web browser to play a tour, wherein the computer program product comprises: program code configured for displaying a tour player in the Web browser; program code configured for allowing a user to select a tour from a plurality of tours stored in a database located remotely from the computer system running the Web browser; program code configured for playing the tour in the tour player; and program code configured for displaying ad content in the Web browser with the tour player, wherein the ad content is dynamically served to the Web browser.

In a fifth aspect, the invention provides a system for playing tours in a viewer, comprising: a system for directing the viewer to a tour database having a plurality of tours stored therein, wherein the tour database is remotely located from a device running the viewer; a tour player for displaying a selected tour in the viewer; and a transaction interface that is displayed with the selected tour in the viewer, wherein the transaction interface provides a mechanism for making purchases over a network.

A further feature of the invention is that tours can be exchanged among users, e.g., via email, along with advertising content and transaction.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a multimedia publishing system in accordance with an embodiment of the present invention.

FIG. 2 depicts a tour player in accordance with an embodiment of the present invention.

FIG. 3 depicts a tour player being utilized to email a tour in accordance with an embodiment of the present invention.

FIG. 4 depicts a tour player being utilized to view a Web page in accordance with an embodiment of the present invention.

FIG. 5 depicts a tour player in a collapse form in accordance with an embodiment of the present invention.

FIG. 6 depicts a tour creation system in accordance with an embodiment of the present invention.

FIG. 7 depicts an ad processing system in accordance with an embodiment of the present invention.

### DETAILED DESCRIPTION OF THE INVENTION

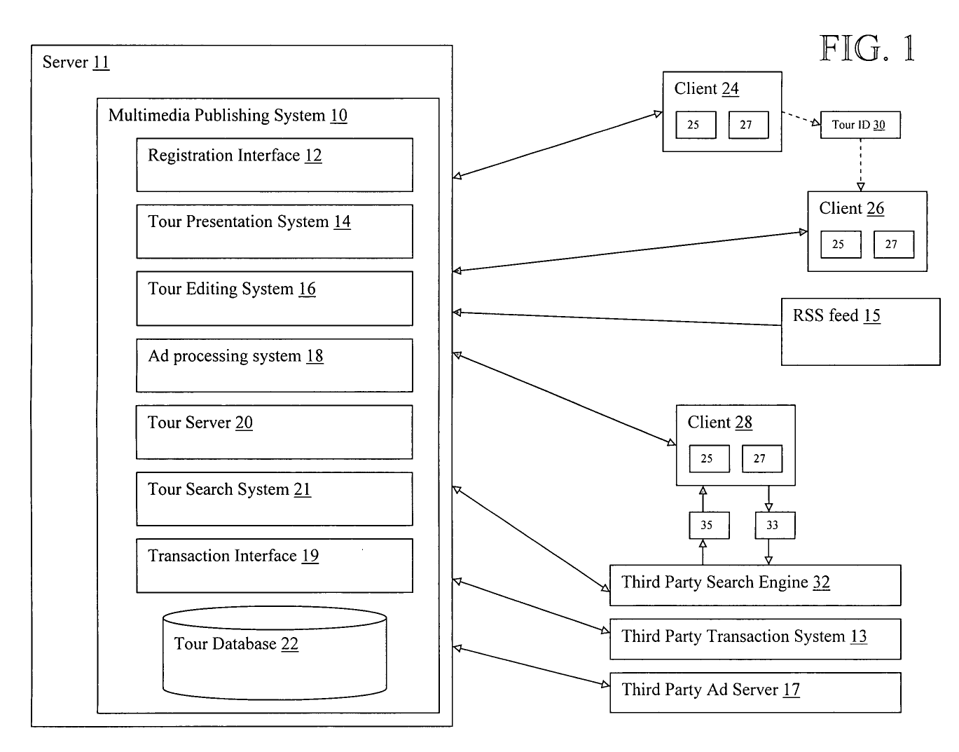

Referring now to the drawings, FIG. 1 depicts a multimedia publishing system 10 for building, publishing, searching, viewing and forwarding tours of multimedia content while providing a dynamic, rules-based advertising model with the ability to conduct transactions. In this illustrative embodiment, multimedia publishing system 10 is implemented on a server 11 accessible via a network such as the World Wide Web (“Web”). Multimedia publishing system 10 includes: a registration interface 12 through which new users can register to use the services of multimedia publishing system 10; a tour presentation system 14 that allows users to view tours through a tour player; a tour editor system 16 that allows users to create new tours and edit existing tours; an advertising (“ad”) processing system 18 that places dynamic advertising content into tours being viewed; a tour server 20 that provides access to tours stored in a tour database 22; a tour search system 21 that allows tours in the tour database 22 to be searched; and a transaction interface 19 that provides an interface to third party transactions 13 allowing users to make purchases.

As shown in FIG. 1, users access multimedia publishing system 10 via clients 24, 26, 28. In a typical embodiment, clients 24, 26, 28 comprise Internet browsers running on computer systems, which are pointed to a Web address (i.e., URL) at which multimedia publishing system 10 resides. In this example, a tour player 25 is being viewed on, and tour editor 27 has been downloaded to each of the clients 24, 26, 28. The operation and functionality of tour player 25 and tour editor 27 are described in further detail below. The editor download process can for example take place when a new user registers with the multimedia publishing system 10 via the registration interface 12.

As shown, tours may be readily published and shared among users of the Web without the need of actually transmitting the tour content. Instead, a tour identifier (ID) 30, e.g., a URL that points to a tour in tour database 22, is used to share tours. For instance, a user at client 24 may have composed a tour using tour editor 27 of various Web pages relating to a vacation destination. Alternatively, the user may have found an existing tour among the various tours stored in tour database 22 using search system 21. Regardless of its origin, the user can share the tour by emailing a tour ID 30 to a second user at client 26, who in turn can utilize his or her tour player 25 to access the tour from the tour database 22 via the tour server 20. Thus, tours are composed and played remotely from where they are permanently stored. Security, such as the use of public/private keys, may be readily incorporated into any communication scheme utilized within the context of the invention.

Tour IDs 30 may include three components, including: (1) an ID that refers to the current tour; (2) a referring URL ID; and (3) an instance ID that defines a collection of tours the current tour resides within, e.g., tours sent to the user, tours created by the user, tours viewed by the user, etc. The concept of instances and instance ID is described in further detail below.

Tours can be searched using a third party search engine 32. For instance, a user at client 28 may submit a search query 33 to the third party search engine 32. A set of search results 35 may be returned that include links to one or more tours located in tour database 22. The user in this case can click on a tour link to view the tour.

As noted above, an ad processing system 18 may be utilized to allow dynamic ad content to be placed in relation to (e.g., run along-side of) tours regardless of when or where the tours are played. For example, a third party ad server 17 such as GOOGLE AD SENSE can be accessed to serve ads that are relevant to the content in the tour. Such ads can “travel” along with a tour that is found during a search, or otherwise forwarded among users.

As described below, tours may comprise different types of multimedia content, e.g., images, video, music, etc. In addition, tours may include content captured from an RSS feed 15. RSS stands for Really Simple Syndication and provides a mechanism to distribute a list of headlines, update notices, and/or other content to tour viewers.

RSS works by having a third party Website maintain a list of notifications on their Website, referred to as an RSS feed. Changes to the Website content can be identified by checking the list. An RSS aggregator can be utilized to automatically access the RSS feeds of any relevant Websites. (RSS feeds and aggregators are also referred to as RSS channels and RSS readers.) Producing an RSS feed for a tour is known to those skilled in the art, as hundreds of thousands of Websites now provide this feature, including major news organizations such as the New York Times, the BBC, and Reuters, as well as many web blogs.

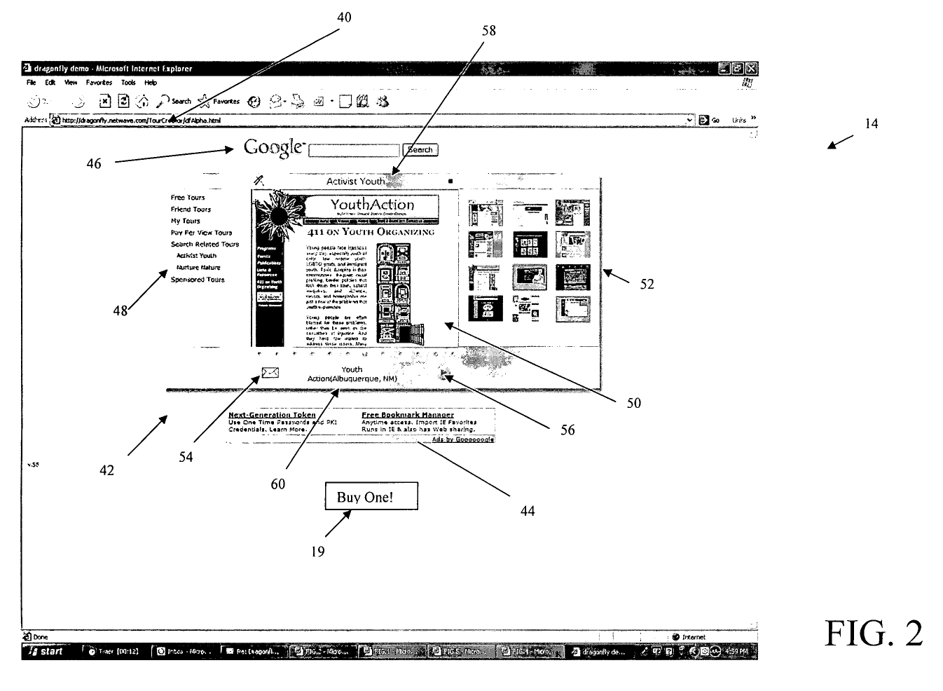

Referring now to FIG. 2, an illustrative embodiment of a tour player 42 is shown in a browser interface 14. As noted above, in order to view the tour player, the browser 14 is pointed to a URL at the server 11 on which the multimedia publishing system 10 resides. As can be seen, the tour player 42 includes three areas that include a directory 48 of existing tours, a main content window 50 for displaying an image in a tour, and a thumbnail window 52 for displaying thumbnails of each of the images in the tour. Tour player 42 also displays a title of the tour 58 and a title of or text about the current image 60 being displayed in the tour. In addition, a brand, e.g., “SONY,” could also be placed on the tour player 42.

In one illustrative embodiment, the tour player 42 is implemented using XML and Web services to facilitate communications with the server 11 and tour database 22. Thus, while the current illustrative embodiment of the invention is described with reference to a browser operating within the context of the Web, the tour player 42 may be embodied in any type of networked devices having a viewing platform, e.g., cellular phone, a wireless device, an application, a display kiosk, an Internet connected device such as a SONY P2P™, etc.

Tours can be viewed by pressing the play button 56, or by selecting individual thumbnails, which will cause the images associated with the selected thumbnail to be displayed in the main content window 50. Thumbnails may be selected in any manner, including by simply passing the cursor over a thumbnail (rollover).

As shown in the directory 48, tours can be arranged into various categories, including free tours that are available to everyone, tours that are received from friends, my tours which are tours composed by the user, pay for view tours that the user must pay for to see, and sponsored tours that include tours from advertisers, e.g., car companies, real estate companies, etc., who pay based on actual usage or performance of the tour. The types of tours could also include business to customer tours, business to business tours, community tours, etc. Accordingly, different privileges may be given to different tours to limit who may or may not view them. Obviously, the specific arrangement and presentation of the available tours can vary without departing from the scope of the invention.

Anytime a tour is presented, one or more content sensitive advertisements 44 can be displayed in an ad window, e.g., below the tour player 42. (Note however that in one illustrative business model, a tour publisher may obtain a license that allows the publisher to forego the presentation of such advertisements.) As described in more detail below, the displayed ads are dynamically produced by ad processing system 18 or a third party ad server 17 based on ad rules that may consider, for instance, the content of the tour, demographics of the user, etc. The ads may be generated based on any set of rules, such as GOOGLE ad rules. Thus, as tours are published, fresh ad content is dynamically generated and displayed any time the tour is viewed. Moreover, the ads can be updated for each tour that is displayed.

Further, a transaction interface 19, in this case a “Buy One” button is provided with the tour that allows an end user to make purchases over the Web. In particular, the Buy One button links the user to a third party transaction system 13 where such a transaction can take place. The type of third party transaction system 13 that is linked to from the transaction interface 19 can be determined in any manner, e.g., based on the content being displayed, etc. In addition, the transaction interface 19 can be displayed in any viewable area, e.g., within the tour player 42, or outside of the tour player 42, as shown. When a tour is distributed over the Web, the transaction interface can likewise be distributed.

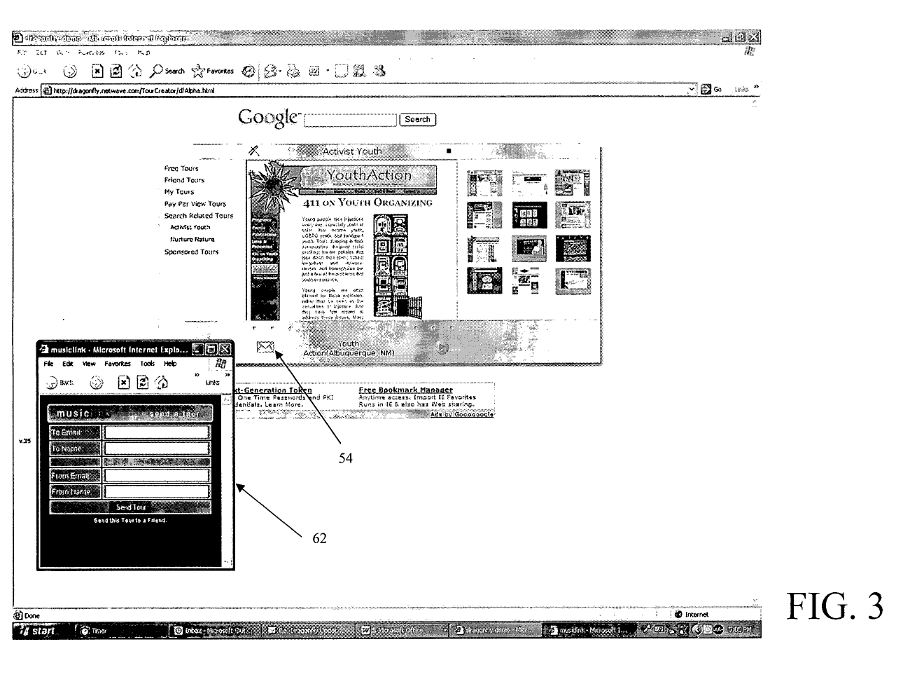

In addition, a send button 54 is provided if the user wants to send the tour to an email recipient. FIG. 3 shows the result of pressing the send button 54. In this embodiment, a new window 62 is opened that allows the user to enter a destination address and name, as well as the source address and name. As noted above, when a tour is emailed, only the tour ID needs to be sent.

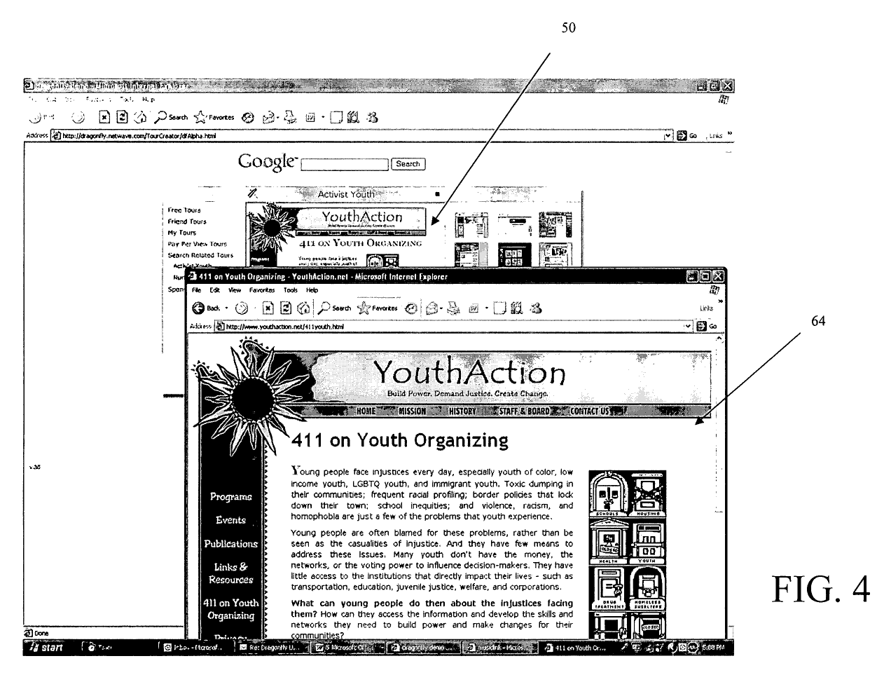

It should be appreciated that tours may be derived from many different types of multimedia content such as web pages, photos, word processing documents, etc. However, images that appear in the tour are converted to and stored in a uniform format (e.g., JPEG, SWF, AVI, PNG, etc.). Thus, the images that appear in the main content window 50 of the tour player 42 are static in nature (i.e., non-HTML based). However, if a user wants to view the actual version of what appears in the main content window 50, the user can simply click on the image in the main content window 50. This will result in a new browser window being opened with the actual live content. An example of this linking process is shown in FIG. 4, in which a browser window 64 is opened with the actual web page of the image appearing in the main content window 50 of the tour player. Thus, the user can easily navigate from the tour player 42 to the actual content associated with the tour image content.

In some cases, the actual content associated with the tour images appearing in the main content window 50 may not be available (e.g., images may be derived from photos or documents stored on another user's computer). In this case, the linking process described above can be disabled.

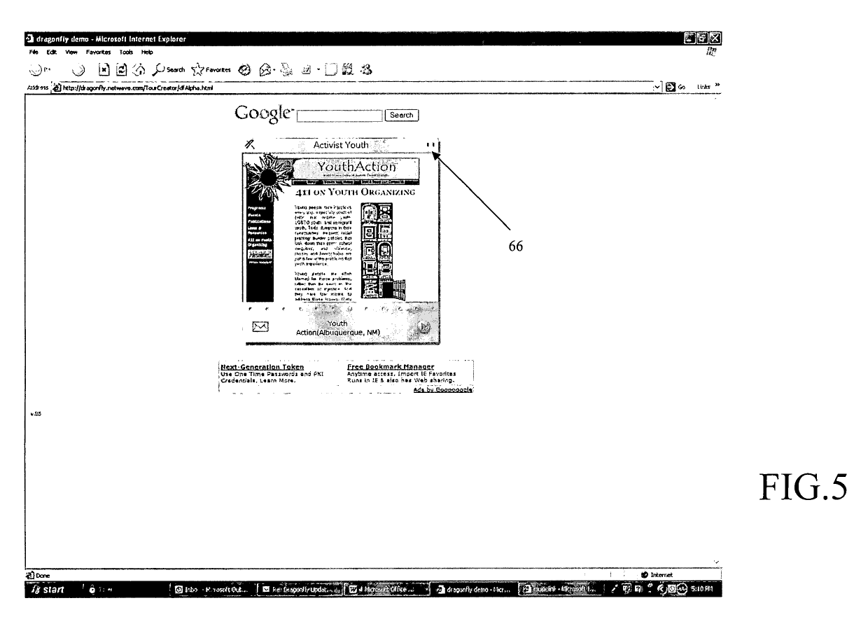

FIG. 5 depicts an additional viewing option for the tour player 42. Specifically, by clicking the collapse/expand button 66, the user is able to hide the directory 48 and thumbnail window 52, leaving just the main content window 50. Obviously, the viewing options may change, e.g., to accommodate devices having smaller viewing areas, such as cell phones.

It should be appreciated that the tour player 42 may be implemented in any fashion. In one illustrative embodiment, it can be implemented using MACROMEDIA FLASH® technology. In addition, because the process of playing a tour involves accessing the tour from a remote database, a slight time lag may exist. To address this, an initial slide (e.g., an ad, an introduction, etc.) may be preloaded with tour player 42, which can play while the actual tour is being fetched.

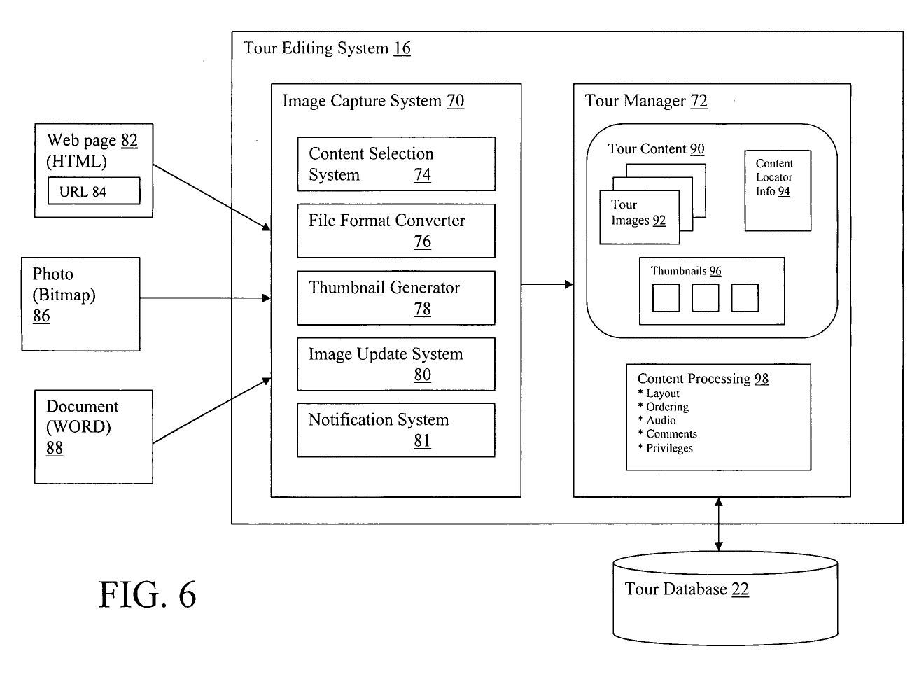

Referring to FIG. 6, a more detailed system diagram of the tour editing system 16 is shown. Tour editing system 16 includes an image capture system 70 for capturing and converting images, and a tour manager 72 for processing and storing tours in the tour database 22. As noted above, tours may be derived from any type of multimedia content, such as a web page 82 (e.g., in HTML format), a photo 86 (e.g., in a bitmap format), and a document 88 (e.g., in a MICROSOFT WORD™ format). Obviously, any format file, such as PDF, ASCII, TIFF, WAV, MP3, etc., that is capable of being displayed or presented by a computer system, could likewise be captured. A user can build a tour utilizing a tour editor 27 (see FIG. 1), which allows the user to select images appearing on/residing on their computer via a content selection system 74. In one illustrative embodiment, images appearing on the screen of a user's computer can be captured by typing a control key on the keyboard (such as “˜”). If the image is accessible via the Web, such as a Web page, a URL 84 or other locator information will also be captured. It should be understood that the tour editor 27 may reside on either or both of the server or client system.

Once selected, file format converter 76 converts the captured image to a tour image in a uniform, non-HTML format, such as a JPEG. In addition, thumbnail generator 78 generates a thumbnail image of the captured image, e.g., in a SWF format. Thumbnails 96 may also be generated via a separate process/server, e.g., using Web services.

Tour content 90 comprised of tour images 92, thumbnails 96 and content locator information 94 is then stored by tour manager 72 in the tour database 22. Note that because the stored tour images 92 comprise static “pictures” of potentially dynamic content (e.g., a Web page), image update system 80 may be employed to update these tour images from time to time in the tour database 22. When content is changed in a tour by an author, the tour editing system 16 updates the images in the tour database 22. In either case, a notification system 81 may be implemented to send notification to all viewers of a tour when an update is available.

Content processing system 98 provides a mechanism through which the layout and ordering of images in the tour can be implemented. Moreover, additional media content, such as comments, audio files, etc., can be added to images by content processing system 98 in the tour being edited/created.

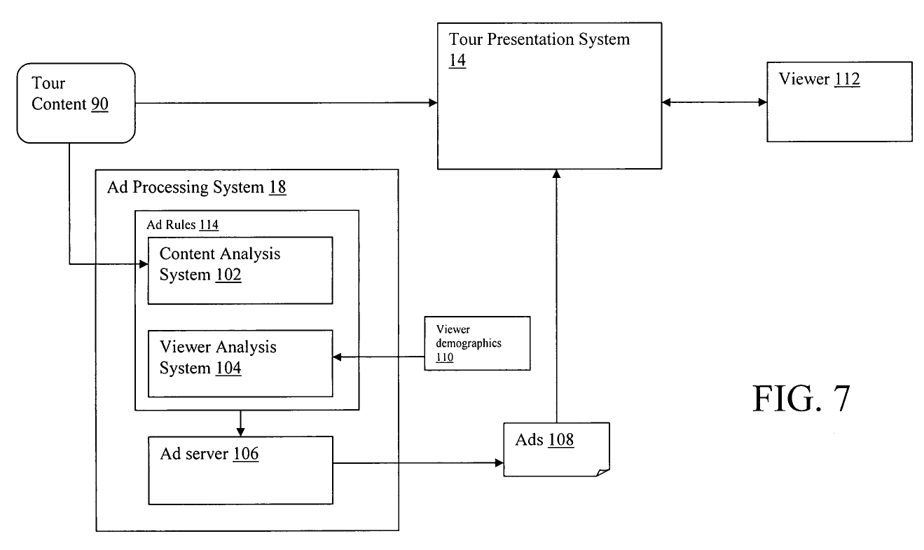

FIG. 7 depicts a system diagram showing how ad processing system 18 interacts with tour presentation system 14. In particular, when tour content 90 is loaded into tour presentation system 14 for the viewer 112, a set of ad rules 114 are applied to determine what ads should appear in the browser with the tour images. The ad rules 114 may include a content analysis system 102 for analyzing tour content 90, as well as a viewer analysis system 104 to determine appropriate ads based on viewer demographics 110. Content analysis system 102 may also analyze statistics such as views and forwarding frequency to determine viewer preferences for content appearing in a tour or tours. Based on the analysis, ad server 106 generates one or more ads 108 to be displayed by the tour presentation system 14 to viewer 112. Alternatively, a similar process may likewise be used by a third party ad server 17.

As noted above, tours are communicated over a network using a tour ID 30 (FIG. 1). In one illustrative embodiment, tour ID 30 includes an instance that is used to manage the data collections of the tour player users and tour editors. The instance provides a list of tours that the tour player 14 can play (i.e., it dictates what appears in the left panel 42 of the player shown in FIG. 2).

Based on: (1) the user who is running the player; (2) the instance; (3) the message (e.g., email or IM), if there was one, that carried the information to start the player; and (4) the tour that is currently loaded into the player, a number of outputs can be generated for the tour player 14. These outputs may include: (1) the list of tours that appears in the left pane of the player; (2) the list of tours that are included in the search function of the player (the search space); (3) the default tour that should be started by the player; (4) whether the tour can be edited; (4) whether the tour is “locked”, i.e., whether its content can be copied to another tour in the editor; and (5) the “skin” used for the player.

At its most basic level, an instance is a number (ID) that is used as an input to the functions described above. This number is passed into the tour player 14 from the HTML that instantiates the SWF file running the tour player 14. Thus, for example, the web page in which the player is embedded may define the instance. Since the instance affects the way the player behaves, the instance provides a “model number” for controlling the player. Different instances of the player look and act differently, based on their model number. Accordingly, while the underlying player is the same for all users, different behavior is achieved based on the inputted instance or instances.

For example, a commercial client may want their own customized players that only list their tours. Thus, a car manufacturer's web site may have several instances: one for each model.

The search space of an instance can be larger than the tours in its display list. For example, all of the General Motors instances may search all of the General Motors tours, so even if a user was looking at the Corvette tours, available tours would include tours in the Chevrolet Suburban instance.

In one illustrative embodiment, there may be three “types” of instances: personal instances, community instances, and commercial instances. These all behave the same way, and are all defined in an instance table, but they have some different properties and are referenced from other tables in different ways.

Every user, registered or not, has a “personal” instance that is personalized to that one user. The tours that are displayed in the left pane of the player for that instance are the tours in the “personal playlist” for that user. The personal playlist is provided by the tour server 20, which has a Web application that generates this “personal playlist” page dynamically based on the user identifier. Also, running the player and/or editor locally is defined to run in the personal instance.

Note that a single tour can be in many instances, because an instance only contains references to tours. This is how one of the General Motors tours can show up in a personal playlist.

Community instances are used to manage tours for communities, which are groups of users. The idea is that these users share a common interest. For example, there might be a community of dog lovers. Each user in the community has an instance that is associated with that community. It is important to note that this is a different instance from that user's personal instance (personal playlist). Thus, a user may be a member of the dog lovers' community, and also the bicycling community. In this case, the user has at least three instances: the personal instance, the dog lovers' instance, and the bicycling instance. Each of these instances has tours associated with them. In this case, the tours probably do not overlap much, but they can.

Commercial instances provide a mechanism for essentially implementing a pay-per-view (PPV) system that may, e.g., be managed completely from a commercial entity, e.g., a third-party e-commerce system. Commercial tours have a property indicating that they are PPV, and the PPV system uses the tour ID and user ID to manage the enabling. The tour player then requires authorization from the PPV system before playing the tour.

It should be understood that multimedia publishing system 10 may be implemented in any type of computer system. Such a computer system generally includes a processor, input/output (I/O), memory, and a bus. The processor may comprise a single processing unit, or be distributed across one or more processing units in one or more locations, e.g., on a client and server. Memory may comprise any known type of data storage and/or transmission media, including magnetic media, optical media, random access memory (RAM), read-only memory (ROM), a data cache, a data object, etc. Moreover, memory may reside at a single physical location, comprising one or more types of data storage, or be distributed across a plurality of physical systems in various forms.

I/O may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. The bus provides a communication link between each of the components in the computer system and likewise may comprise any known type of transmission link, including electrical, optical, wireless, etc. Although not shown, additional components, such as cache memory, communication systems, system software, etc., may be incorporated into the computer system.

Access to computer system may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi, cable, satellite, cell phone, Bluetooth, e or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

In one illustrative embodiment, the architecture of the system may include:

(1) A number of data structures that are related to media content including verified media stored directly in the database and non-verified media stored and referenced externally, user accounts and account management, and media access statistics.

(2) A rich set of web services for remotely calling and modifying the above data structures.

(3) Business Logic for providing rules or intelligence that control the access and distribution of the media.

(4) A Web based editor for creating and modifying media tours.

(5) A distribution process for publishing out completed media tours to Web hosting facilities and media distribution services. In addition authors are able to quickly and efficiently make modifications to existing media tours on the fly.

(6) A Player comprising a Web-based (e.g., Flash) trusted application that does not require end-user verification for installation. The player is a SMART interface between the user and the media distribution system as well as a SMART interface between the user and data collection services.

The architecture allows for very powerful associations between tours, sites and users with a minimal amount of file transfers. This is achieved by the virtualization of these above mentioned associations. What this means is that tours, users and sites can be created and manipulated on the fly through simple business logic processes at a central site without the need to do physical file copies or transfers. For example, users A and B are both registered users. User A receives a marketing campaign for a new handheld device, and automatically appears in the player of user A. User A can then forward the campaign to user B using a send option. When user B opens her email, she finds a simple link and clicks on it. That simple link brings up her player and makes a web service call; the database now returns an XML menu structure with her personal tours as well as the tour sent by user A. At no time was an actual binary media file sent between users A and B.

Furthermore, it should be appreciated that the teachings of the present invention could be offered as a business method on a subscription or fee basis. For example, a computer system comprising multimedia publishing system 10 could be created, maintained and/or deployed by a service provider that offers the functions described herein for customers. That is, a service provider could offer to create, store, publish, and search, etc., tours as described above.

It is also understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part of all of the invention could be implemented in a distributed manner, e.g., over a network such as the Internet or over a cell phone network.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A system for providing multimedia tours, comprising:
a tour editing system for creating and editing a tour at a first client system, wherein the tour editing system includes a system for capturing images of different formats, a system for converting captured images to tour images having a common format, and a system for storing the tour in a remote database located apart from said first client system; and
a tour presentation system having a tour player that can be run from a second client system, wherein the tour player includes a system for accessing the tour from the remote database, a system for playing the tour, and a system for linking to content associated with tour images appearing in the tour.

2. The system of claim 1, wherein the tour editing system includes a system for creating thumbnail images for each of the captured images.

3. The system of claim 1, wherein the common format comprises format selected from the group consisting of: a JPEG format and a SWF format.

4. The system of claim 1, wherein the remote database comprises a plurality of tours created by a plurality of different users, and wherein the plurality of tours in the remote database can be searched by a Web search system.

5. The system of claim 1, wherein at least one of the first and second client systems comprises a system selected from the group consisting of: a Web browser, a cellular phone, and a mobile device.

6. The system of claim 1, wherein the remote database is located at a Web server.

7. The system of claim 1, wherein the tour includes a tour identifier that can be shared among a plurality of users over a network in order to allow the plurality of users to access and view the tour from the remote database.

8. The system of claim 1, wherein the captured images are derived from files selected from the group comprising: an HTML file, a JPEG file, a bitmap file, a word processing file, a PDF file, an MP3 file, a SWF file and an AVI file.

9. The system of claim 1, further comprising an ad processing system that dynamically generates and displays ad content whenever the tour is played at a client system.

10. The system of claim 9, wherein the ad content travels with the tour when the tour is forwarded among users.

11. The system of claim 1, further comprising a transaction system that provides an interface for accessing third party transactions over a network.

12. A method for playing a tour in a viewer, comprising:
pointing the viewer to a tour database having a plurality of tours stored therein, wherein the tour database is remotely located from a device running the viewer;
displaying a tour player in the viewer;
playing the tour in the tour player; and
displaying ad content in relation to the viewer with the tour player, wherein the ad content is dependent upon a set of ad rules.

13. The method of claim 12, comprising the further step of interfacing with a third party transaction system.

14. The method of claim 12, wherein the step of pointing the viewer to a tour database includes the steps of:
submitting a query to a search system;
receiving back a list of search results, wherein at least one of the search results comprises a tour located in the tour database; and
selecting the tour from the list of search results.

15. The method of claim 12, comprising the further step of emailing a tour identifier to a recipient.

16. The method of claim 12, comprising the further step of linking to a Web page by selecting an image in the tour.

17. The method of claim 12, wherein the ad content travels with the tour when the tour is forwarded among users.

18. The method of claim 12, wherein the ad rules are determined by a system selected from the group consisting of: an ad processing system and a third party ad server.

19. A method for composing a tour that can be played in a Web browser, comprising:
capturing images from Web pages being viewed on a computer system, wherein the Web pages have an HTML format;
converting the captured images to a set of tour images having a non-HTML format;
composing the tour from the tour images; and
storing the tour in a remote database located apart from the computer system.

20. The method of claim 19, further comprising the steps of:
capturing images from non-HTML files; and
converting the captured images to the non-HTML format.

21. The method of claim 20, wherein each image in the set of tour images includes locator information that links the images to the Web pages from which they were captured.

22. The method of claim 20, comprising the further step of generating a set of thumbnail images.

23. The method of claim 20, comprising the further step of updating the tour images when the Web pages are modified.

24. The method of claim 20, comprising the further step of notifying viewers of a tour that the tour images have been updated.

25. A computer program product stored in computer memory that is downloadable to a remote computer system where the computer program product can be executed to play a tour, wherein the computer program product comprises:
program code configured for displaying a tour player in a viewing platform;
program code configured for allowing a user to select a tour from a plurality of tours stored in a database located remotely from the computer system running the viewing platform;
program code configured for playing the tour in the tour player; and
program code configured for displaying ad content with the tour player, wherein the ad content is dynamically served to the tour player.

26. The computer program product of claim 25, further comprising program code configured for displaying a set of thumbnail images in the tour player.

27. The computer program product of claim 25, further comprising program code configured for allowing a first user to email a tour identifier to a second user.

28. The computer program product of claim 25, wherein the viewing platform comprises a Web browser.

29. The computer program product of claim 25, further comprising program code configured for allowing a user to link to a Web page by selecting an image in the tour.

30. A system for playing tours in a viewer, comprising:
a system for directing the viewer to a tour database having a plurality of tours stored therein, wherein the tour database is remotely located from a device running the viewer;
a tour player for displaying a selected tour in the viewer; and
a transaction interface that is displayed with the selected tour in the viewer, wherein the transaction interface provides a mechanism for making an interactive transaction over a network.

31. The system of claim 30, further comprising a system for updating a tour whenever tour content changes.

32. The system of claim 30, wherein the interactive transaction comprises a purchase.
